(19) United States
(12) Patent Application Publication
(10) Pub. No.: US 2004/0055962 A1
(43) Pub. Date: Mar. 25, 2004

(54) Process and apparatus for removal of heavy metals from wastewater

(76) Inventor: Josh H. Golden, Santa Cruz, CA (US)

Correspondence Address: Michael I. Falkoff, IONICS, INCORPORATED, 65 Grove Street, Waltertown, MA, 02472, US

(21) Appl. No.: 10/662,185

(22) Filed: Sep. 12, 2003

Related U.S. Application Data
(63) Continuation of application No. 09/893,152, filed on Jun. 26, 2001, now abandoned.

(51) Int. Cl. C02F 1/52

(52) U.S. Cl. 210/725

(57) ABSTRACT

A method and system for removing heavy metals from wastewaters is provided wherein the wastewaters are pre-treated with a polymeric metal removing agent to assist in the removal of the heavy metals. The polymeric metal removing agent promotes the precipitation of large particles which may then be filtered by a high flow rate, low pressure filtration system.

### FIELD OF THE INVENTION

The present invention relates generally to a method and system for removal of heavy metals from aqueous solutions such as wastewaters. More specifically, the present invention provides an improved method and system for removing heavy metals from wastewaters using pre-treatment with polymeric agents to assist removal of the heavy metals.

### BACKGROUND OF THE INVENTION

Many industrial industries including mining, metal plating, metal finishing, and semiconductor manufacturing are strictly regulated with regard to the level of contaminants, particularly organic materials and heavy metals, in their discharged wastewaters. Strict discharge limits have been adopted for heavy metal contaminants deemed harmful to humans and aquatic organisms. Such heavy metal contaminants include, but are not limited to: cadmium, chromium, copper, lead, mercury, nickel, zinc, and semi-metals such as arsenic and selenium. As a result, a variety of metal removal processes have been proposed to reduce the heavy metal content in industrial wastewater to meet the increasingly stringent discharge limits.

Heavy metal contaminants are typically removed in bulk by precipitation as the metal oxide and hydroxide. The precipitate is then removed by settling, coagulation, and in some cases, filtration. Most transition metal ions are easily precipitated in this way, but the minimum concentration that can be obtained is limited by the solubility of the precipitate. As discharge limits become more stringent, further removal is required. To remove the residual soluble metal contaminants, the effluent from the precipitation process may be treated with a metal scavenging or removal agent to remove the trace metal contaminants, and thus meet discharge regulations. These metal scavenging agents may be precipitants, absorbents, or metal specific ion exchange resins. Metal precipitation agents include sulfides, thiocarbonates, alkyl dithiocarbamates, mercaptans, and modified natural products. Semi-metals such as selenium and arsenic are not readily precipitated as the hydroxide or by precipitant metal scavenging agents, but may be removed by coagulation and adsorption processes involving aluminum or iron based coagulants.

Most common metal scavenging agents have limitations. After reaction with the metal contaminant, the metal complexes derived from the metal scavenging agents of thiocarbonates, sulfides, mercaptans, and thiocarbamates, form a fine powder-like precipitate. This fine powder-like precipitate does not settle or filter easily. Addition of a coagulant or flocculating agent is typically needed to achieve efficient removal of these suspended solids. Additionally, many scavenging agents are very toxic and care must be taken to ensure that they are not present in the discharged wastewater.

The fine powder-like particles that are formed by traditional metal precipitation agents such as sulfides, thiocarbonates, alkyl dithiocarbamates, mercaptans, and modified natural products are susceptible to clogging, and may even pass through, the membranes used in most filtration systems. An example of a filtration system is described in U.S. Pat. Nos. 5,871,648 and 5,904,853, which provide for high flow rate removal of contaminants from wastewaters. Maintaining high filtration efficiencies in such a system requires the presence of large particles, as opposed to fine powder like particles.

To satisfy the need for a metal scavenging agent that is less toxic and also forms a large, fast settling floc, highly efficient metal chelating polymers have been developed. One example of a water soluble polymer is known as a poly(dithiocarbamate) and is effectively used to treat wastewaters containing heavy metals so that the effluent meets or exceeds discharge requirements for heavy metals. These polymers are currently marketed by Betz-Dearborn Inc. and Nalco Inc., under the respective trade names of METCLEAR 2405 and NALMET. Use and composition of the polymeric metal scavengers are further described in U.S. Pat. Nos. 5,500,133; 5,523,002; 5,658,487; 5,164,095; and 5,510,040. Thus, while some improvements have been made, there is a continuing need to develop further improved systems and method for removal of heavy metal contaminants in wastewaters, particularly a method that provides for high flow rate removal of the contaminants.

### SUMMARY OF THE INVENTION

Accordingly, it is an object of the present invention to provide an improved system and method of removing heavy metal contaminants from wastewaters.

More particularly it is an object of the present invention to provide a system and method that employs a polymeric agent that forms large particles which are then filtered using a high flow rate filtration system to remove heavy metal contaminants from wastewaters.

These and other objects and advantages are achieved by the method of the present invention for removing heavy metal contaminants from wastewaters comprising the steps of: providing a wastewater including one or more heavy metal contaminants; adjusting to the pH of the wastewater to a pH of about 7 or greater to precipitate oxides and hydroxides of the heavy metals, and where soluble heavy metals remain in the wastewater; introducing a polymeric metal removing agent to substantially precipitate the remaining soluble heavy metals; and removing the precipitates formed in the previous steps from the wastewater thereby substantially removing the heavy metal contaminants.

In another aspect of the present invention, a system is provided, comprising a first reaction tank for receiving the wastewater and wherein the pH of the wastewater is adjusted to a pH of about 7 or greater; a first mixer coupled to the first reaction tank for mixing the wastewater to assist precipitation of oxides and hydroxides of the heavy metals and wherein soluble metals remain in the wastewater; a second reaction tank for receiving the wastewater from the first reaction tank; injection means coupled to the second reaction tank for injecting a polymeric metal removal agent into the second reaction tank; a second mixer coupled to the second reaction tank for mixing the wastewater to assist precipitation of the remaining soluble metals; and a filtration system for receiving the wastewater and precipitates from the second reaction tank. The filtration system includes one or more filter vessels having one or more filter membranes arranged in a tubular sock configuration and placed over a slotted tube, and one or more settling tanks.

### BRIEF DESCRIPTION OF THE DRAWINGS

Other objects and advantages of the present invention will become apparent upon reading the detailed description of the invention and the appended claims provided below, and upon reference to the drawing, in which:

FIG. 1 is a schematic diagram of a system employed in accordance with the present invention.

### DETAILED DESCRIPTION OF THE INVENTION

The inventor has discovered a new system and method for removing heavy metal contaminants from wastewaters which employs the use of a polymeric metal removing agent to form large particles which are then removed using a high flow rate filtration system. This particular system and method provide for the efficient and relatively quick removal of heavy metals, and which effectively removes such contaminants to part per billion (ppb) concentrations.

In particular, the system and method of the present invention utilizes a polymeric metal removing agent, in particular poly-dithiocarbamates to efficiently scavenge metals and to form large particles (also referred to as a precipitate or floc) that is stable and easily filtered. The particles may be filtered using a micro-filtration system, in particular a filtration system such as the EnChem™ filtration system as described in U.S. Pat. Nos. 5,871,648 and 5,904,853. U.S. Pat. Nos. 5,871,648 and 5,904,853 are hereby incorporated by reference in their entirety. The system and method of the present invention provides a significant advantage in the high flow removal of heavy metal contaminants from wastewaters. The EnChem™ system employs the formation of large filterable particles to maintain filtration efficiency.

Of particular advantage, the present invention may be carried out without the aid of additional coagulant agents, unlike the prior art processes. Of course, additional coagulant agents may be used if desired, but they are not necessary. This is because use of the polymeric metal removal agents with or without additional coagulant agents will provide large particles that are effectively filtered by high flow rate filtration systems, such as the EnChem™ apparatus.

In general, one aspect the present invention provides a method of removing heavy metal contaminants from wastewaters wherein a wastewater is provided that includes one or more heavy metal contaminants. The heavy metal contaminants may include, but are not limited to: cadmium, chromium, copper, lead, mercury, nickel, zinc, and semi-metals such as arsenic, selenium, and the like. Such contaminants are present in the wastewater in a wide range of initial concentrations, and typically are present in the range of about 1 to 500 ppm. According to the present invention, the pH of the wastewater is then adjusted to a pH of about 7 or greater, preferably in the range of 7 to 11, with a pH of 8 being most preferred. Raising the pH causes bulk precipitation of metal oxides and hydroxides. However, soluble heavy metals are still present in the wastewater. Preferably, the bulk precipitate is removed from the wastewater by gravity settling and the like, however this is not a requirement, and the next step of adding the polymeric agent may be preformed prior to removal of the bulk precipitates.

To remove the remaining soluble heavy metals, a polymeric metal removing agent is introduced into the wastewater. The polymeric metal removing agent is a polymeric dithiocarbamate material. Polymeric dithiocarbamate materials suitable for use in the present invention are water soluble and preferably include Nalmet, and MetClear 2405. Preferably, the pH is maintained in a range of about 5 to 11 during addition and reaction of the polymeric agent. The reaction is allowed to occur for a sufficient period of time to allow for precipitation of the remaining soluble heavy metals, and generally will be in the range of about 1 to 60 minutes. The polymeric dithiocarbamate material is added to the wastewater at a concentration in the range of about 2 to 300 ppm, with about 20 ppm being most preferred.

Of particular advantage, the polymeric dithiocarbamate material creates relatively large particles that may be filtered without causing the clogging problems experienced when filtering small, powder-like particles. The relatively large particles are preferably of a size in the range of about 10 to 500 microns in diameter. Without being bound by any particular theory, the inventor believes that the polymeric nature and large extended macromolecular structure of the method removal agent leads to the formation of large particles.

Preferably, although not necessarily, coagulants and/or flocculating agents by may optionally added to aid in the precipitation of the solids. If this step is preformed, the coagulant and/or flocculants are preferably added after the addition of the polymeric metal removal agent. Suitable coagulants and flocculants are organic or inorganic, or a combination thereof, and may be polymeric, either anionic or cationic, with a molecular weight in the range of about 5,000 to 500,000. Specific examples of inorganic coagulants and floculants include, but are not limited to: sodium aluminate, aluminum trihydrate, and ferric chloride. Specific examples of polymeric organic coagulants and flocculants include, but are not limited to EPI-DMA, DADMAC, and DADMAC-polyacrylamide.

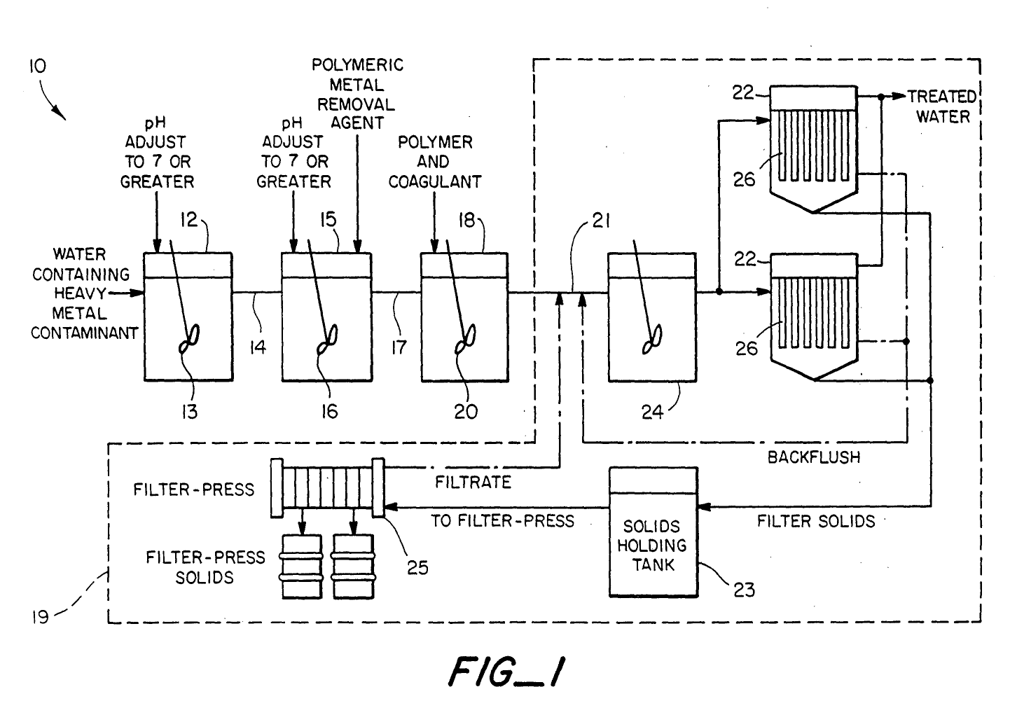

The method of the present invention may be carried out in any suitable filtration system. However, preferably, the method is carried out in the system of the present invention which is illustrated in FIG. 1. FIG. 1 shows a heavy metal removal system 10 of the present invention, generally comprised of one or more reaction tanks, associated mixers, and a filtration system. Specifically, wastewaters containing heavy metal contaminants are fed to a first reaction tank 12. The pH of the wastewater in the first reaction tank 12 is adjusted via conventional means to a pH of 7 or greater, and preferably in a pH range of about 7 to 11, with a pH of 8 being most preferred. The wastewater is stirred or agitated with a mixer 13, and metal oxides and hydroxides begin to precipitate out of solution. The precipitation reaction in the first tank takes place for a period of time in the range of about 2 to 60 minutes, and more preferably for a period of time in the range of about 5 to 15 minutes.

The precipitated solids may be removed at this point, if desired. The solids are typically removed by gravity settling or filtration. The wastewater, with or without the precipitated solids, is then fed to a second reaction tank 15 via delivery line 14. The wastewater contains insoluble heavy metals which were not precipitated out in the first reaction tank 12. To precipitate these remaining soluble heavy metals, the polymeric metal removing agent is added to the second reaction tank 15. The polymeric metal removal agent is in liquid form and may be diluted to the desired concentration. Preferably, the concentration of the polymeric metal removal agent added to the wastewater is in the range of about 2 to 300 ppm, with 20 being most preferred. Although not shown, the polymeric metal removing agent may alternatively be added inline, by an inline mixer placed within the delivery line 14. The pH of the wastewater in the second reaction tank 15 is preferably adjusted to a pH in the range of about 5 to 11 by conventional pH adjustment means. A mixer 16 is coupled to the second reaction tank 15 to ensure adequate mixing of the wastewater and the polymeric agent.

With the addition of the polymeric agent, in the recited pH range, the remaining soluble heavy metals begin to precipitate out of the solution and form large particles. The reaction occurs for a period of time sufficient to precipitate substantially all of the remaining soluble heavy metal contaminants, and will vary depending on the size of the second reaction tank 15 and the concentration of the contaminants, but will generally be in the range of about 1 to 60 minutes, and preferably in the range of about 5 to 30 minutes.

Once the precipitation of the remaining heavy metal contaminants is complete, the wastewater and precipitates are fed via delivery line 17 to either one of: a third reaction tank 18 or a filtration system 19. In the embodiment where the wastewater is fed to a third reaction tank 18 with mixer 20, coagulants and/or flocculants are preferably added to the wastewater to further coagulate the particles in preparation for filtration. The pH of the wastewater solution is maintained during this step at a pH in the range of about 6 to 8. The coagulants and/or flocculants are added at a concentration in the range of about 2 to 200 ppm. The reaction is allowed to occur for at least ten minutes, and preferably for a period of time in the range of about 10 to 60 minutes.

Once the reaction is complete, the wastewater containing the precipitates is filtered by conveying the wastewater to the filtration system 19 via delivery line 21. Prior to filtration, some of the precipitates may be removed by gravity settling, and the like. For example, the metal oxides and hydroxides may be removed in this manner prior to the filtration step.

In an alternative embodiment, the wastewater and precipitates are fed directly to the filtration system 19 via delivery line 17, and do not pass through a third reaction tank. Thus, in this embodiment, no coagulants and/or flocculants are used. However, as above, some of the precipitates may be removed by gravity settling and the like prior to filtration.

Any filtration system 19 may be used; however, the filtration system 19 is preferably a high flow rate, low pressure, micro-filtration system such as that commercially available as EnChem™ system and described in U.S. Pat. Nos. 5,871,648 and 5,904,853, the entire disclosures of which are hereby incorporated by reference.

Referring again to FIG. 1, the preferred filtration system 19 according to the system of the present invention is illustrated.

In this example, the filtration system 19 generally includes one or more filter tanks or vessels 22 and a settling or sludge holding tank 23. A backflush tank 24 may be used and is preferably placed prior to the filter tanks 22. The filter tank 22 is operated in two modes; namely, a filter tank operating mode and the filter tank backflush mode. The filter tank 22 generally includes a filtration membrane in a tubular “sock” configuration. The membrane sock is placed over a slotted tube to prevent the sock from collapsing during use. The membrane material is commercially available from a variety of sources, and preferably has a pore size in the range of 0.5 to 10 microns, with a pore size of 1 micron being most preferred.

During the operation mode, the particles are dewatered and filtered from the wastewater. The wastewater is pumped from the filter vessel 22 through the membrane, and as the wastewater passes through the membrane, the particles do not pass through, and instead build up on the outside of the membrane surface. The filtered wastewater is pumped out of the filter tank 22 to a backflush tank 24. The filtered wastewater is substantially free of heavy metals, and contains a heavy metal concentration of equal to or less than 100 ppb, and more preferably equal to or less than 50 ppb.

More specifically, the filter tank is preferably equipped with an array of microfiltration membranes 26. Preferably, the microfiltration membranes that are used in a tubular “sock”configuration to maximize surface area. The membrane sock is placed over a slotted support tube to prevent the sock from collapsing during use. In order to achieve the high flow rates and flux values, a number of membranes or membrane modules, each containing a number of individual filter socks, are used. The microfiltration membranes preferably have a pore size in the range from 0.5 μm to 10 μm microns, and preferably from 0.5 μm to 1.0 μm. It has been found that the treated wastewater flow rate through 0.5 to 1 μm microfiltration membranes can be in the range from 200 GFD to 1500 GFD.

The microfiltration membranes are preferably provided in cassette or module or in a preformed plate containing the membrane array. In either case, the membranes are conveniently installed or removed from the top by unscrewing a collar fitting. Alternatively, the entire cassette or plate may be removed for servicing. The microfiltration membranes provide a positive particle separation in a high recovery dead head filtration array. The dead head filtration operates effectively at low pressures (i.e. in the range of about 3 psi to 25 psi, preferably 5 psi to 10 psi) and high flow rates, allowing a one pass treatment with up to 99.9% discharge of the supplied water. Most preferably, the microfiltration system 19 is operated at a maximum pressure of about 10 psi. Solids which accumulate on the membrane surface during filtration are periodically backflushed away (and gravity settled) from the membrane surface to ensure a continuously clean filtration media. Currently, the preferred filter socks useful with the present invention contain a Teflon® coating on a poly(propylene) or poly(ethylene) felt backing material. Such socks are available from W. L. Gore. Another presently preferred filter sock manufactured by National Filter Media, Salt Lake City, Utah, consists of a polypropylene woven membrane bonded to a poly(propylene) or poly(ethylene) felt backing. Because the membranes are simple and inexpensive, some operations deem it more cost-effective to replace the membrane socks instead of cleaning contaminants from the membrane. However, it should be noted that the membranes are very resistant to chemical attack from acids, alkalis, reducing agents, and some oxidizing agents. Descaling of the membranes is achieved by acid washing, while removal of biofouling may be accomplished by treatment with hydrogen peroxide, dilute bleach, or other suitable agents.

To remove the heavy metal precipitates from the membrane surface and the filter vessel, the filter vessel 22 is placed in backflush mode. The membranes are periodically backflushed to keep the flow rate high through the system. Solids are preferably removed from the membrane surface by periodically backflushing the microfiltration membranes and draining the filtration vessel within which the membranes are located. Preferably, the backflush is initiated when the pressure at the membrane builds to approximately 6 psi. The periodic, short duration backflush removes any buildup of contaminants from the walls of the microfiltration membrane socks. Backflush is achieved but is not restricted to a gravity scheme, i.e., one in which a valve is opened and the 1 to 2 feet of water headspace above the filter array provides the force that sloughs off the filter cake. The dislodged solid material within the filtration vessel is then transferred into a sludge holding tank for further processing of the solids. The microfiltration as described is fully automated and can run 24 hours, seven days a week, with minimal input from the operator. The system is completely automated using process logic control (PLC) which can communicate with supervisory and control data acquisition systems (SCADA). Simple and rugged hardware continuously monitors the characteristics of the influent and effluent and adjusts the chemical feed as needed. Examples of parameters automatically monitored include pH, turbidity, oxidation reduction potential, particle zeta potential, and metal contaminant concentration. Process development and fine-tuning is achieved by continuous monitoring of the process parameters followed by control adjustment. In the backflush mode, the flow of the system is reversed where water from the headspace above the filter arrays flows in reverse. This is achieved by opening a valve on the filter tank. The particles or sludge settles on the bottom of the filter vessel 22, and then are pumped or gravity feed to the sludge holding tank 23 and removed. A filter press 25 may be used to provide further dewatering of the particles, if desired. It is important to note that while one type of treatment system has been described, the method of the present invention may be carried out in a wide number of different types of treatment systems, such as for example gravity settling and cross-flow filtration systems. Since the precipitates are large, the filtration system is able to operate at high flow rates and low pressures.

A restriction in the use of the polymeric removal agent in the present invention is that it is destroyed in an oxidizing environment. Oxidizing chemical additives that will destroy the metal scavenging agent include, but are not restricted to: bleach, chlorine, hydrogen peroxide, permanganate, and Fenton's reagent.

### EXPERIMENTAL

The following prospective example is provided for illustration purposes only, and in not intended to limit the invention in any way.

Wastewater derived from the manufacture of semiconductor devices includes effluent from chemical mechanical polishing processes (CMP). Wastewater derived from copper CMP typically contains 2 to 5 ppm cupric ion, even at elevated pH levels, due to the presence of solubilizing agents such as ammonia and other metal complexing agents. CMP wastewaters containing copper and other dissolved heavy metals can have flow rates that exceed 100 gallons per minute (gpm), and thus require effective removal of suspended solids and dissolved heavy metals at these high flow rates.

To practice the method and system of the present invention, an EnChem™ microfiltration system is preferably installed at a large semiconductor manufacturing facility that discharges copper CMP wastewater at 250 gpm. A 400 gpm EnChem™ system would preferably be installed because of its high flow rate capability and high flux of 800 GPD (gallons/ft²·day), and small footprint (30′×75′). To remove copper and suspended solids in such a high flow rate and high flux environment, the method is carried out as follows:

CMP wastewater containing suspended silica and alumina as well as 5 ppm of soluble cupric ion is collected in a first reaction tank having a capacity of 2,500 gallons at pH 4. The pH is then adjusted to the range of 7 to 11, with a pH of 8 being preferred. The pH adjustment is used to precipitate metals as the oxide or hydroxide.

Prior to pumping the wastewater to the second reaction tank (5,000 gallons), a polymeric metal removal agent, Metclear 2405 (Betz-Dearbom), is injected inline so that the concentration of the polymer in the wastewater is in the range of 2 to 300 ppm, with 20 ppm being preferred. Alternatively, the polymer is injected directly into the second reaction tank. The mixture is gently stirred to create large particles, as the metal removal polymer removes the dissolved copper and other heavy metals by flocculation. The large particles (10 to 500 microns in diameter) created by the polymer are essential for the final microfiltration step.

Prior to transferring the wastewater to a third reaction tank (2,500 gallons), an aluminum coagulation agent, sodium aluminate, is injected inline so that the concentration in the wastewater ranges from 10 to 500 ppm, with 200 ppm preferred. A cationic polymer (EPI-DMA) with a molecular weight of approximately 250,000, was co-injected slightly downstream of the coagulant so that the concentration ranged from 1 to 50 ppm, with 5 ppm preferred. The reaction mixture was gently stirred so that the large particles containing the agglomerated suspended solids and copper were not disturbed.

The combined mixture from the third reaction tank is gravity fed into two EnChem™ filtration tanks in parallel. The large particles are effectively filtered with the microfiltration system at average flows of 250 gpm. The filter pressure rose to a maximum of 5 psi in 15 minutes, after which time a backflush sequence was initiated. After backflush, the pressure dropped to 0.5 psi and the cycle continued without failure, and fully automated for 24 hours, 7 days a week, for 6 months. Daily analysis of the treated wastewater yielded a turbidity value of 0.1 NTU and a residual copper concentration of <0.050 ppm (via inductively coupled plasma spectroscopy).

As will be recognized by those skilled in the art, the present invention provides many advantages. For example, the present invention uses polymeric agents that exhibit low toxicity. The system and method are capable of removing heavy metal contaminants to concentrations to very low levels, and is effective for most toxic metals. The precipitation of larger particles result in reduced sludge volume and lower disposal costs.

As taught by the foregoing description and examples, an improved method for removing heavy metal contaminants from wastewaters has been provided by the present invention. The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

I claim:

1. A method for removing heavy metal contaminants from wastewaters, comprising the steps of:
providing a wastewater including one or more heavy metal contaminants;
adjusting to the pH of the wastewater to a pH of about 7 or greater to precipitate oxides and hydroxides of the heavy metals, and where soluble heavy metals remain in the wastewater;
introducing a polymeric metal removing agent to substantially precipitate the remaining soluble heavy metals; and
removing the precipitates formed in the previous steps from the wastewater thereby substantially removing the heavy metal contaminants.

2. The method of claim 1 wherein the pH of the wastewater is adjusted to a pH in the range of about 7 to 11.

3. The method of claim 1 wherein the polymeric metal removing agent is a polymeric dithiocarbamate material.

4. The method of claim 3 wherein the polymeric dithiocarbamate material is selected from the group of: Nalmet and MetClear 2405.

5. The method of claim 1 wherein the polymeric metal removing agent is introduced at a concentration in the range of 2 to 300 ppm in the wastewater.

6. The method of claim 1 wherein the polymeric metal removing agent is introduced at a concentration of about 20 ppm in the wastewater.

7. The method of claim 1 wherein the pH of the wastewater is maintained in the range of about 5 to 11 during introduction of the polymeric material.

8. The method of claim 1 wherein the precipitate formed of the remaining soluble heavy metals have a particle diameter in the range of about 10 to 500 microns.

9. The method of claim 1 fuirther comprising the step of: adding coagulants and/or flocculants to the wastewater.

10. A system for removing heavy metal contaminants from wastewaters, comprising:
a first reaction tank for receiving the wastewater and wherein the pH of the wastewater is adjusted to a pH of about 7 or greater;
a first mixer coupled to the first reaction tank for mixing the wastewater to assist precipitation of oxides and hydroxides of the heavy metals and wherein soluble metals remain in the wastewater;
a second reaction tank for receiving the wastewater from the first reaction tank;
injection means coupled to the second reaction tank for injecting a polymeric metal removal agent into the second reaction tank;
a second mixer coupled to the second reaction tank for mixing the wastewater to assist precipitation of the remaining soluble metals;
a filtration system for receiving the wastewater and precipitates from the second reaction tank, said filtration system including one or more filter vessels having one or more filter membranes arranged in a tubular sock configuration and placed over a slotted tube, and one or more settling tanks.

11. The system of claim 10 wherein said filtration system is capable of filtering the wastewater at a flow rate of up to 800 gallon/ft²/day.

12. The system of claim 10 wherein the filtration system is operated at a maximum pressure of about 10 psi.
